(19) United States
(12) Patent Application Publication
(10) Pub. No.: US 2025/0103704 A1
(43) Pub. Date: Mar. 27, 2025

(54) SYSTEM AND METHOD FOR DETECTING DOCUMENT OBJECT MODEL CROSS-SITE SCRIPTING VULNERABILITY

(71) Applicant: Radware Ltd., Tel Aviv (IL)

(72) Inventors: Amir MARMOR, Arugot (IL); David AVIV, Tel Aviv (IL); Gabi NAKIBLY, Tel Aviv (IL)

(73) Assignee: Radware Ltd., Tel Aviv (IL)

(21) Appl. No.: 18/471,923

(22) Filed: Sep. 21, 2023

(51) Int. Cl. G06F 21/55

(52) U.S. Cl. CPC G06F 21/554

(57) ABSTRACT

A system and method for detecting document object model cross-site scripting (DOM-XSS) vulnerability. The method includes identifying at least one data flow in a client-side code, wherein each of the at least one data flow is between an attacker-controllable source and a security sensitive sink, wherein the client-side code includes a DOM representation of a web page; injecting an indicator string in the attacker-controllable source of the client-side code; executing an injected client-side code, wherein the injected client-side code includes the indicator string; detecting the indicator string in the security sensitive sink of the at least one data flow; and performing mitigation action upon detecting the indicator string.

### TECHNICAL FIELD

The present disclosure relates generally to web application attacks, and particularly to detecting document object model cross-site-scripting vulnerabilities.

### BACKGROUND

Web applications are advantageous for a number of reasons, among them is that the application can be updated easily by the author(s) from a single point, which eliminates having multiple versions of software ‘in the wild’, and in general provides the author with more control over their software. Web applications also provide users with the ability to use applications without requiring downloading special software, libraries, plugins, and so on. Web applications, however, are vulnerable to web-based threats, and as such, require security solutions.

To be protected, companies heavily invest in security solutions, such as anti-malware software and firewalls. However, as security solutions become more and more advanced, so do web attacks. Web attacks may be in the form of viruses, worms, Trojan horses, script-based, system intrusions, and many others. Such attacks allow the attacker to control computers, access confidential information, and destroy valuable data.

One such security solution is a web application firewall (WAF). A WAF is typically deployed in-line of traffic between clients and a server hosting a protected web-application. A WAF filters, monitors, and blocks hypertext transfer protocol (HTTP) traffic to and from a web application. This is achieved by supplying the WAF with authorization rules or security policies to determine what traffic should be filtered, blocked, or let through. The security policies are configured based on known attack patterns or vulnerable application-paths and defined as a blocklist (what should be blocked) or a whitelist (what should be allowed). However, the WAF is limited to protection of attacks detected in the traffic between clients and the server and oblivious to security risks that may be imposed at, for example, each of the clients, and more.

Document object model (DOM) is a data representation of a document, such as a Hypertext Markup Language (HTML) of the web application, including nodes and objects and is executed at the clients as part of a client-side code. The DOM represents content, style, and structure of the document from the point of view of the client browser, which can be dynamically modified using script languages such as, JavaScript®. The users of the client devices can readily interact and utilize the web application based on the DOM representations and modifications. To this end, without proper security, attackers can manipulate the DOM by injecting and executing malicious codes at the client browser, thereby taking control over the client to access, for example and without limitation, user data, backend database, privileged applications, functions, illicit content, and more, while abusing server bandwidth. Such attack through injection of malicious code, often at the attacker-controllable source, is known as DOM-based cross-site scripting (DOM-XSS) vulnerability.

DOM-XSS vulnerabilities can be remediated with proper sanitization (or filtering) of the client-side code. Thus, techniques to efficiently detect potential vulnerabilities and analyze sanitization effectiveness are needed. It has been identified that traditional techniques for defending against XSS attacks, such as WAF or other server-side attack detection and prevention tools typically do not apply to DOM-XSS vulnerabilities, attributed to their entire presence and execution at the client-side. Moreover, some solutions based on manual and/or automatic testing of DOM-XSS vulnerabilities using browser's developer tools are often limited to static reading of the code, which may result in higher false positive and/or false negative detections. In addition, DOM-XSS vulnerabilities are becoming more difficult to detect as more complex logics are being provided to the client with the advancement of web applications.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for detecting document object model cross-site scripting (DOM-XSS) vulnerability. The method comprises: identifying at least one data flow in a client-side code, wherein each of the at least one data flow is between an attacker-controllable source and a security sensitive sink, wherein the client-side code includes a DOM representation of a web page; injecting an indicator string in the attacker-controllable source of the client-side code; executing an injected client-side code, wherein the injected client-side code includes the indicator string; detecting the indicator string in the security sensitive sink of the at least one data flow; and performing mitigation action upon detecting the indicator string.

Certain embodiments disclosed herein also include a non-transitory computer readable medium having stored thereon causing a processing circuitry to execute a process, the process comprising: identifying at least one data flow in a client-side code, wherein each of the at least one data flow is between an attacker-controllable source and a security sensitive sink, wherein the client-side code includes a DOM representation of a web page; injecting an indicator string in the attacker-controllable source of the client-side code; executing an injected client-side code, wherein the injected client-side code includes the indicator string; detecting the indicator string in the security sensitive sink of the at least one data flow; and performing mitigation action upon detecting the indicator string.

Certain embodiments disclosed herein also include a system for detecting document object model cross-site scripting (DOM-XSS) vulnerability. The system comprises: a processing circuitry; and a memory, the memory containing instructions that, when executed by the processing circuitry, configure the system to: identify at least one data flow in a client-side code, wherein each of the at least one data flow is between an attacker-controllable source and a security sensitive sink, wherein the client-side code includes a DOM representation of a web page; inject an indicator string in the attacker-controllable source of the client-side code; execute an injected client-side code, wherein the injected client-side code includes the indicator string; detect the indicator string in the security sensitive sink of the at least one data flow; and perform mitigation action upon detecting the indicator string.

Certain embodiments disclosed herein include the method, non-transitory computer readable medium, or system noted above, wherein the indicator string includes characters commonly used in hypertext markup language (HTML).

Certain embodiments disclosed herein include the method, non-transitory computer readable medium, or system noted above, wherein the indicator string includes a unique character that indicates a specific attacker-controllable source of the at least one data flow.

Certain embodiments disclosed herein include the method, non-transitory computer readable medium, or system noted above, further including or being configured to perform the following steps: generating a notification, based on the detecting of the indicator string, to indicate detection of DOM-XSS vulnerability.

Certain embodiments disclosed herein include the method, non-transitory computer readable medium, or system noted above, wherein the notification includes at least one of: the at least one data flow, the attacker-controllable source, the security sensitive sink, and a sanitization effectivity.

Certain embodiments disclosed herein include the method, non-transitory computer readable medium, or system noted above, further including or being configured to perform the following steps: retrieving the client-side code from a server; and downloading the client-side code.

Certain embodiments disclosed herein include the method, non-transitory computer readable medium, or system noted above, further including or being configured to perform the following steps: periodically repeating the detection of the DOM-XSS vulnerability.

Certain embodiments disclosed herein include the method, non-transitory computer readable medium, or system noted above, further including or being configured to perform the following steps: identifying at least one input string from a plurality of sinks; searching the at least one input string in a plurality of potential sources; and determining a pair of the attacker-controllable source and the security sensitive based on identifying the at least one input string in the attacker-controllable source, wherein the attacker-controllable source is selected from the plurality of potential sources.

Certain embodiments disclosed herein include the method, non-transitory computer readable medium, or system noted above, wherein the attacker-controllable source is selected from a predetermined list of potential attacker-controllable sources.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for detecting document object model-based cross-site scripting (DOM-XSS) vulnerability according to an embodiment.

FIG. 3 is a flowchart illustrating a method for identifying at least one data flow according to an embodiment.

FIG. 4 are example codes showing potential DOM-XSS vulnerabilities according to example embodiments.

FIG. 5 is a schematic diagram of a system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for detecting document object model cross-site scripting (DOM-XSS) vulnerabilities in web application. The client-side codes of web pages are pre-scanned to detect DOM-XSS vulnerabilities that may cause security threats at the client-side. Such DOM-XSS vulnerabilities may be accurately and precisely detected for remediation before exploitation. The disclosed embodiments provide techniques to analyze the client-side code to identify true data flows between attacker-controllable sources and security sensitive sinks, which are otherwise challenging using traditional methods that cannot readily access the client-side code. Each of the data flow are tested for potential DOM-XSS vulnerabilities caused by insufficient sanitization. It should be noted that the dynamic analysis (i.e., active running) of the client-side codes for identification of the true and complete data flows enables accurate and efficient determination of vulnerabilities. Such improved vulnerability detection adds a security layer to predict and prevent DOM-XSS attacks that are often added during runtime at a client browser.

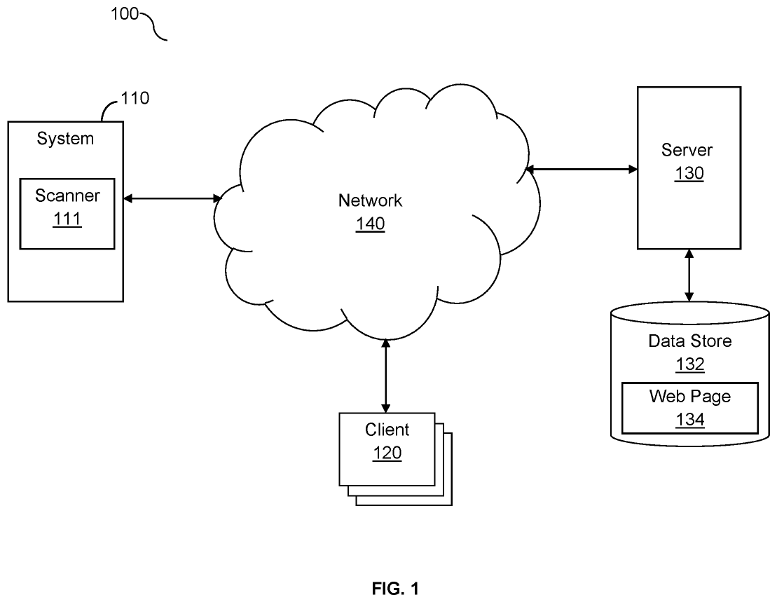

FIG. 1 shows an example network diagram 100 utilized to describe the various disclosed embodiments. In the example network diagram 100, a system 110 and a client 120 communicates with the server 130 over a network 140. The network 140 may be, but is not limited to, a wireless, cellular or wired network, a local area network (LAN), a wide area network (WAN), a metro area network (MAN), the Internet, the worldwide web (WWW), similar networks, and any combination thereof.

The client 120 is a web browser, or other type of legitimate web application client, or web user agent, and the like, that is operated by a real legitimate user, or other legitimate web client entities. The client 120 is configured to send Hypertext Transfer Protocol (HTTP) requests to a server 130 to receive a client-side code of the web page 134 (or simply referred as web page code 134), which is executed at the client 120. The client-side code of the web page 134 may be written in languages such as, but is not limited to, Hypertext Markup Language (HTML), Cascading Style Sheets (CSS), JavaScript®, and the like, and any combination thereof, and is responsible for enabling display of the web page 134 to a user at the client-side 120. Such web page code 134 includes a DOM that may be utilized to dynamically modify the content, style, structure of the web page 134 at the client browser.

It should be noted that such client-side code of the web page 134 may be subject to DOM-XSS vulnerabilities due to injection of a malicious code. The malicious code may be injected during runtime, and more. As an example, a client 120 may become compromised by an attacker when a client-side code including a malicious code is executed at the client 120. The client 120 may be executed over a computing device such as, but not limited to, a server, a mobile device, a personal computer, a laptop, a tablet computer, a smart phone, a wearable computing device, an IoT device, a TV system, and the like.

The server 130 is a web server, an application server, or the like that provides content upon receiving a request from the client 120. The server 130 is configured to host one or more applications that each include at least one web page 134. The web page 134 is a document or an information resource that is provided to a client 120, upon a request, for access and execution. The structure and content of the web page 134 is defined by scripting languages such as, but not limited to, HTML, CSS, Javascript®, and the like, and any combination thereof. In particular, the display of the web page 134 is manipulated by a document object model (DOM) representation, which is enabled by modifying the client-side code using scripting languages such as, but not limited to, JavaScript®. The DOM represents the web page 134 as nodes and objects that describes the structure and the content of the document.

According to the disclosed embodiments, the server 130 may be referred to as a target server for attackers to inject malicious code to manipulate the DOM of its web page 134. In such as case, a DOM-XSS vulnerable web page 134 may be retrieved, and the injected malicious code is executed together with the web page code 134 at the client 120. It should be noted that the server 130 (or entities of the server 130) is responsible for providing secure web page 134 to clients 120.

The server 130 is connected to a datastore 132 that stores application related data including, and without limitation, the web page 134, and more, which may be sent to the client 120 and/or the system 110.

The system 110 is a device, component, server, or the like, configured to detect DOM-XSS vulnerabilities in the client-side code of the web page 134. The system 110 is configured to identify viable data flow between attacker-controllable sources (herein onward referred to as “sources”) and security sensitive sinks (herein onward referred to as “sinks”) by downloading and analyzing the client-side code of the web page 134. The source is a JavaScript® property that can potentially take in malicious codes (or values) from the attacker and pass to the sink which is a location or function that executes the malicious code. The execution at the sink may cause undesirable and potentially dangerous effects on the browser and/or system that is executing it.

The data flow between the source-sink pair suggests a potential vulnerability in which a modification of value at this source results in data distribution and processing at a function of the associated sink. The system 110 is configured to dynamically analyze and identify the data flow by running the client-side code, for example, the JavaScript® code. It should be noted that such dynamic analysis demonstrates actual data flow between identified source-sink pairs to reduce both false positives and false negatives. That is, source-sink pairs with true data flow between them are identified.

In addition, the system 110 may include a scanner 111 that is configured to inject an indicator string in the web page code 134. The scanner 111 may be an agent to perform tasks of testing the web page in order to scan for a web page with actual DOM-XSS vulnerability amongst a plurality of web pages. In an embodiment, the indicator string may be written using script languages such as, but not limited to, JavaScript®, and the like, into the source. In a further embodiment, the indicator string includes characters such as, but not limited to, ′, ″, <,>, and the like, and any combination thereof that are commonly used in HTML markup and generally necessary for successful DOM-XSS. The scanner 111 is configured to test (or scan) the identified data flows by injecting the indicator strings at the sources and monitoring at the corresponding sinks upon executing the injected client-side code of the web page.

In an embodiment, the scanner 111 may determine DOM-XSS vulnerabilities at a particular source-sink pair by detecting the indicator string at the sink. Scanning of each data flow indicates sanitization effectiveness at each source-pair data flow. As an example, when an indicator string is detected at the sink of a first source-sink pair, the first source-sink pair may be determined to have poor or no sanitization, and thus, vulnerable to DOM-XSS. In another example, when the indicator string is not detected at the sink of a second source-sink pair, the second source-sink pair is determined to be effectively sanitized and thus, has less or no DOM-XSS vulnerability. In such a scenario, the proper sanitization removes or substitutes at least portions of the characters in the indicator string. The system 110 of the disclosed embodiments audits the server 130 for DOM-XSS vulnerabilities to allow elimination of any potential dangers before a security breach occurs at the executed client 120.

It should be noted that testing, according to the disclosed embodiments, enables verification of DOM-XSS exploitability at one or more data flows in the web page code 134, which eliminates false positives. It should be further noted that scanning the identified portions of source-sink pairs rather than all sources and sinks in the client-side code reduces processing time and power, thereby conserving computing resources. According to the disclosed embodiments, the system 110 is configured to analyze, for example, continuously simultaneously, consecutively, and the like, one or more source-sink pairs of a plurality of web pages 134 of the server 130.

The system 110 is further configured to generate notifications including potential DOM-XSS vulnerabilities of the web page 134 and/or web application. In an embodiment, the notification may be caused to be displayed at an operator device (not shown) associated with the target server 130. The notification may include, for example, but is not limited to, web application, web page, attacker-controllable source, security sensitive sink, data flow between the source-sink pair, sanitization effectiveness of source-sink pairs, and the like, and any combination thereof. In an embodiment, various data, for example, but not limited to, attacker-controllable source, security sensitive sink, data flow between the source-sink pair, sanitization effectiveness of source-sink pairs, and the like, and any combination thereof, obtained at the system 110 may be provided and a stored in the datastore of the server 130.

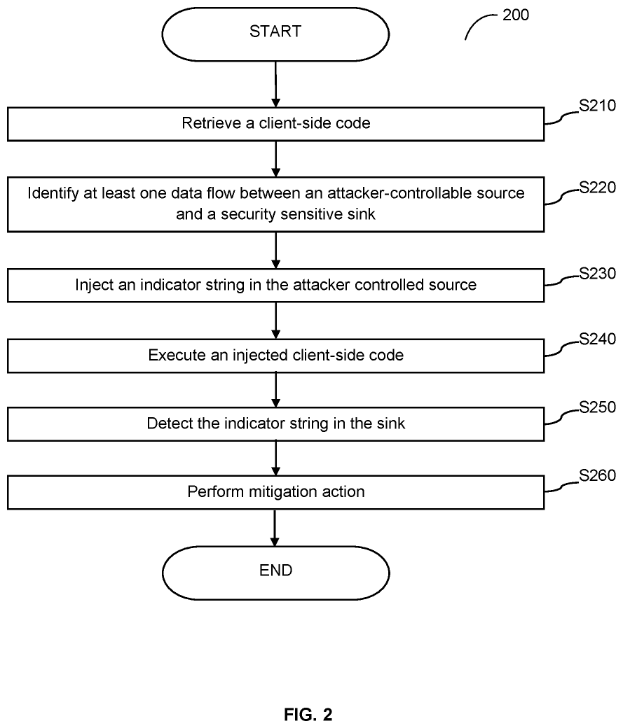

FIG. 2 is an example flowchart 200 illustrating a method for detecting DOM-XSS vulnerabilities in a web page according to an embodiment, The method described herein may be performed at a system 110 including a scanner 111, FIG. 1.

At S210, a client-side code of a web page is retrieved. The client-side code defines the structure and content of the web page and is written in languages such as, but not limited to, HTML, CSS, JavaScript®, and the like, and any combination thereof. A DOM representing the content and display of the web page is created upon accessing the web page code at a browser. The DOM representation is described using, for example, a JavaScript®, which includes attacker-controllable sources and security sensitive sinks. When a DOM-XSS vulnerability exists, the source includes a malicious code that is passed to the sink, unsanitized, to be processed to cause undesirable effect and/or compromising at the client-side. In an embodiment, the client-side code is retrieved from a datastore (e.g., the datastore 132, FIG. 1) connected to a server (e.g., the server 130, FIG. 1). In a further embodiment, the client-side code may be downloaded and stored at a memory and/or database of a system (e.g., the system 110, FIG. 1).

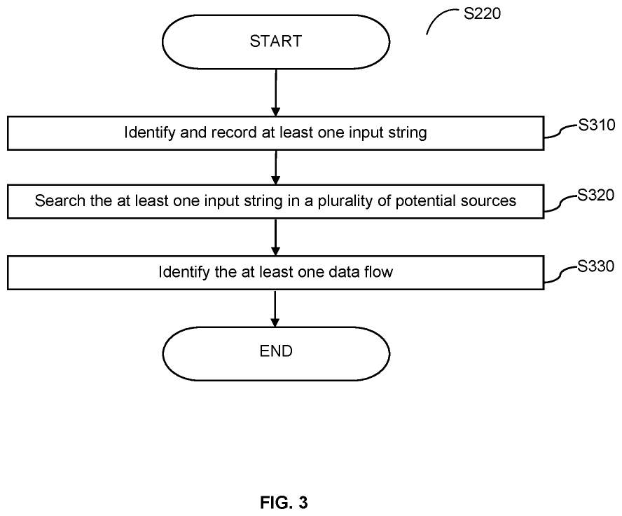

At S220, at least one data flow between the sources and the sinks is identified. The data flow between a source-sink pair indicates passing of source code (or property) to the sink (e.g., JavaScript® functions or DOM objects) for consuming, processing, displaying, and the like. One or more data flow may be identified between the sources and sinks in the client-side code, which are potential paths of threat. The source may be selected from a predetermined list of potential sources. The identified data flow may be further analyzed to detect potential DOM-XSS vulnerabilities. The identification of the at least one data flow is further described below in FIG. 3.

At S230, an indicator string is injected in the source of each of the at least one data flow. The indicator string includes characters such as, but not limited to, ′, ″, <,>, and the like, and any combination thereof to explore, detect, or identify potential XSS vulnerability. Such characters are commonly used HTML and are often necessary for DOM-XSS to succeed and thus, allow close mimicking of the real-world exploitations. In an embodiment, the source and the sink of the at least one data flow may be overridden using, for example, JavaScript®. In an embodiment, the indicator string may be injected into all the sources of the at least one data flow to analyze the at least one data flow. In an example embodiment, the indicator string may be appended to the end of the original value (or property) of the source. In another example embodiment, for a source that includes a Uniform Resource Locator (URL) value, the indicator string may replace or append to the query part of the URL value.

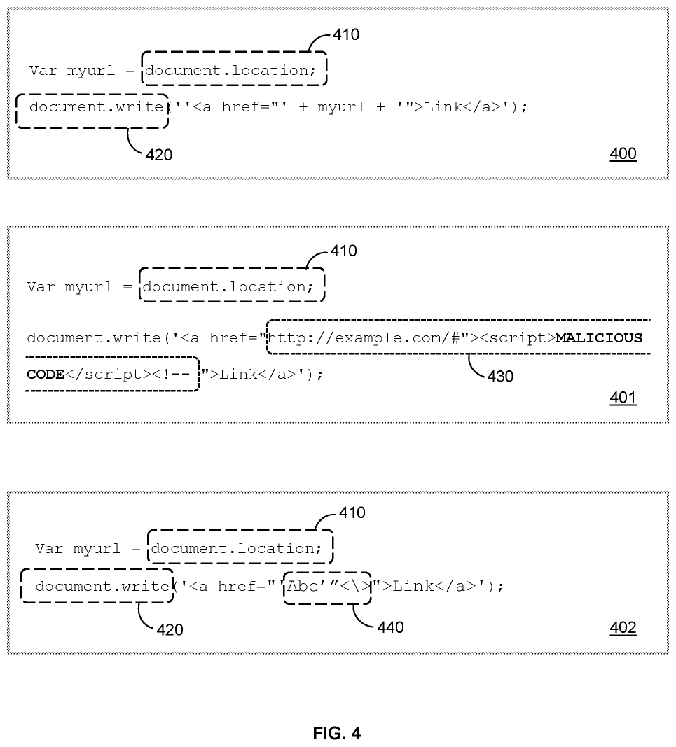

In a further embodiment, a unique indicator string may be embedded for each source in order to distinguish the originating source upon detecting the unique indicator string at the sink. An example of the unique indicator string may be: ‘rand’″< >, where ‘rand’ is a random string. Alternatively to injecting a random string is an injection of a piece of code (e.g., JavaScript® code) that, when executed, generates a random string. In some embodiments, the indicator string may be injected in the source of client-side code before the request is sent to a server (e.g., the server 130, FIG. 1). It should be noted that the indicator string, of the disclosed embodiments, utilizes characters that are used in real-world XSS attacks to exploit the vulnerability. FIG. 4 shown an example code representing the source and the sink including DOM-XSS vulnerability.

At S240, an injected client-side code is executed. The injected client-side code is the client-side code that includes the at least one indicator string in the at least one source-sink pair. The injected client-side code is executed for processing and displaying of the web page. During runtime, the sinks of the at least one data flow are monitored to identify any suspicious data flow from the injected indicator string. In an embodiment, the execution of the injected client-side code simulates a DOM-XSS threat including a complete data flow from the source to the sink along the at least one data flow.

At S250, the indicator string is detected in the sink of the at least one data flow. In an embodiment, the detection of the indicator string at the sink indicates DOM-XSS vulnerability of the client-side code and thus, the web page and/or web application. In a well-protected web page without DOM-XSS vulnerabilities, the indicator string is sanitized and/or filtered out, for example, by removal or substitution of characters, as the string passes through data flow from the source to the sink. To this end, the indicator string (e.g., unaltered, portions, etc.) at the sink indicates unsanitized (or poorly sanitized) data flow and moreover, vulnerability of the web page at the client-side. In addition to detecting DOM-XSS vulnerabilities of the web page, data such as, but not limited to, previously identified source-sink pairs, unique identifier strings for each source, and the like, and any combination thereof, may be utilized to determine the vulnerable source-sink pairs and their data paths.

At S260, when indicator string is detected, a mitigation action is performed. The mitigation action may include, for example, but not limited to, inserting a sanitizing code, updating code to perform filtering, adding code for input validation, adding a content security policy (CSP), and the like, and any combination thereof. The mitigation action may also include reporting the detected vulnerabilities. In an embodiment, a notification may be generated to alert potential vulnerabilities in the web page and/or website. In an example embodiment, the notification may include information about the vulnerability such as, but not limited to, web page, attacker-controllable source, security sensitive sink, data flow between the source-sink pair, sanitization effectivity (e.g., yes/no binary, percentage, etc.), and the like, and more. In an embodiment, the notification and/or modified client-side code may be sent to an operator device (not shown) that is accessed by a user associated with the server (e.g., the server 130, FIG. 1). In a further embodiment, the modified client-side code of the web page may be stored in a datastore of the server (e.g., the datastore 132 and the server 130, FIG. 1).

Detection of DOM-XSS vulnerabilities is described with respect to one web page for simplicity. The method described in FIG. 2 may be performed for a plurality of web pages simultaneously, continuously, and the like, to detect vulnerabilities rapidly and effectively. It should be noted that web applications include a large number of web pages and concurrent and rapid analyses of such web pages are critical for preventing security threats.

In an embodiment, the detection of DOM-XSS vulnerabilities may be performed, for example, continuously, intermittently, periodically, or the like, in order to discover new or previously unknown vulnerabilities and thus, increased security. In an example embodiment, the DOM-XSS vulnerability detection may be repeated, for example, every week, every day, every certain number of days, and the like. In a further example embodiment, a user associated with the target server (e.g., the server 130, FIG. 1) may define the repeated period for detection. Even further, the user may voluntarily initiate DOM-XSS vulnerability detection when desired.

FIG. 3 is an example flow chart S220 illustrating a method of identifying at least one data flow in the client-side code of the web page according to an embodiment. The method described herein may be performed at a system 110, FIG. 1.

At S310, at least one input string is identified and recorded. A plurality of sinks is monitored to identify at least one input string and its substrings during loading of the web page. The identified input strings and substrings are outputs of the sinks through processing. In an embodiment, the plurality of sinks of the web page may be predetermined based on the client-side code of the web page.

At S320, the at least one input string and its substrings are searched in a plurality of potential sources. In an embodiment, the search may be performed on the plurality of potential sources in a predetermined list of potential sources. In a further embodiment, the search is performed on potential sources in the retrieved client-side code.

At S330, at least one data flow is determined. The data flow is the path in which a code (or string) is passed from an attacker-controllable source to a security sensitive sink, which may be identified as a source-sink pair. The attacker-controllable source (herein referred to as source) and the security sensitive sink (herein referred to as sink) of the data flow are identified from the plurality of potential sources and the plurality of sinks, respectively. In an embodiment, the client-side code is run to identify the at least one data flow. It should be noted that such runtime analysis confirms actual data passing from the source to the sink in order to improve accuracy. In an embodiment, the identified at least one data flow may be stored at a memory and/or database (not shown) of a system (e.g., the system 110, FIG. 1). It should be noted at the source-sink pairs of the identified at least one data flow are a subset of all the sources and sinks in the client-side code. Thus, further vulnerability testings are performed on the smaller subset of source-sink pairs rather than all.

FIG. 4 are example codes 400 through 402 according to example embodiments. A vulnerable code 400 shows an attacker-controlled source 410 and a security sensitive sink 420, which may be referred to as a source-sink pair upon identifying a data flow between them. The same references numbers 410 and 420 are used in other examples codes 401 and 402 of FIG. 4 for simplicity.

An HTML markup including a malicious link (also referred herein as malicious input) 430 may be added to the vulnerable code 400 of the web page through a DOM-XSS attack to result a malicious code 401. In absence of proper sanitization, the execution of the malicious code 401 allows the embedded malicious input to be executed when the web page is loaded at a client-side browser causing exploitation of DOM-XSS vulnerability and compromising the client (e.g., the client 120, FIG. 1). It should be noted that, with proper sanitization, the malicious input 430 may be removed and/or replaced to prevent execution at the client. In the example malicious code 401 shown in FIG. 4, the malicious input 430 is http://example.com/#″><script>MALICIOUS CODE</script><!-.

According to the disclosed embodiments, an indicator string may be injected to a client-side code in order to detect DOM-XSS vulnerability of the vulnerable code. An example injected code 402 shows the example vulnerable code 400 including an indicator string 440, for example, Abc′″<\>, to potentially flow from attacker-controllable source 410 to the security sensitive sink 420. The exploitability of the DOM-XSS vulnerability of the client-side code is scanned through dynamic testing of the injected code 402. Such testing identifies actual vulnerabilities (e.g., sanitized vs. unsanitized, and the like) through execution of the injected code 402 and checking for the indicator string at the security sensitive sink 420. It should be noted that scanning of vulnerable codes in the client-side code by such tests reduce false positive and false negatives in vulnerability detection. It should be further noted that the method described herein enables accurate detection of DOM-XSS vulnerabilities that are not otherwise discernable from, for example, client-side code reading.

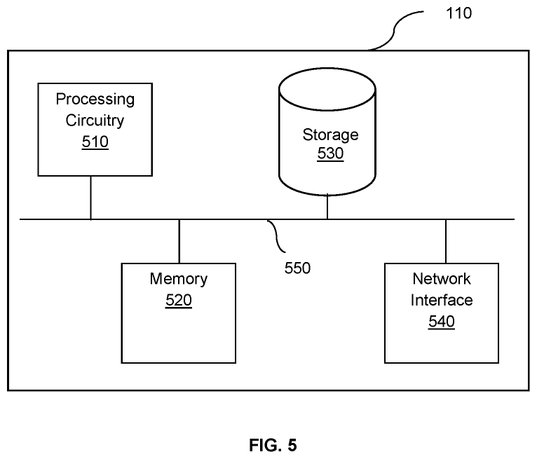

FIG. 5 is an example schematic diagram of a system 110 according to an embodiment. The system 110 includes a processing circuitry 510 coupled to a memory 520, a storage 530, and a network interface 540. In an embodiment, the components of the system 110 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the system 110 to communicate with, for example, the client 120, the server 130, and the like.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for detecting document object model cross-site scripting (DOM-XSS) vulnerability, comprising:
identifying at least one data flow in a client-side code, wherein each of the at least one data flow is between an attacker-controllable source and a security sensitive sink, wherein the client-side code includes a DOM representation of a web page;
injecting an indicator string in the attacker-controllable source of the client-side code;
executing an injected client-side code, wherein the injected client-side code includes the indicator string;
detecting the indicator string in the security sensitive sink of the at least one data flow; and
performing mitigation action upon detecting the indicator string.

2. The method of claim 1, wherein the indicator string includes characters commonly used in hypertext markup language (HTML).

3. The method of claim 1, wherein the indicator string includes a unique character that indicates a specific attacker-controllable source of the at least one data flow.

4. The method of claim 1, further comprising:
generating a notification, based on the detecting of the indicator string, to indicate detection of DOM-XSS vulnerability.

5. The method of claim 4, wherein the notification includes at least one of: the at least one data flow, the attacker-controllable source, the security sensitive sink, and a sanitization effectivity.

6. The method of claim 1, further comprising:
retrieving the client-side code from a server; and
downloading the client-side code.

7. The method of claim 1, further comprising:
periodically repeating the detection of the DOM-XSS vulnerability.

8. The method of claim 1, wherein identifying the data flow further comprises:
identifying at least one input string from a plurality of sinks;
searching the at least one input string in a plurality of potential sources; and
determining a pair of the attacker-controllable source and the security sensitive sink based on identifying the at least one input string in the attacker-controllable source, wherein the attacker-controllable source is selected from the plurality of potential sources.

9. The method of claim 1, wherein the attacker-controllable source is selected from a predetermined list of potential attacker-controllable sources.

10. A non-transitory computer readable medium having stored thereon instructions for causing a processing circuitry to execute a process, the process comprising:
identifying at least one data flow in a client-side code, wherein each of the at least one data flow is between an attacker-controllable source and a security sensitive sink, wherein the client-side code includes a DOM representation of a web page;
injecting an indicator string in the attacker-controllable source of the client-side code;
executing an injected client-side code, wherein the injected client-side code includes the indicator string;
detecting the indicator string in the security sensitive sink of the at least one data flow; and
performing mitigation action upon detecting the indicator string.

11. A system for detecting document object model cross-site scripting (DOM-XSS) vulnerability, comprising:
a processing circuitry; and
a memory, the memory containing instructions that, when executed by the processing circuitry, configure the system to:
identify at least one data flow in a client-side code, wherein each of the at least one data flow is between an attacker-controllable source and a security sensitive sink, wherein the client-side code includes a DOM representation of a web page;
inject an indicator string in the attacker-controllable source of the client-side code;
execute an injected client-side code, wherein the injected client-side code includes the indicator string;
detect the indicator string in the security sensitive sink of the at least one data flow; and
perform mitigation action upon detecting the indicator string.

12. The system of claim 11, wherein the indicator string includes characters commonly used in hypertext markup language (HTML).

13. The system of claim 11, wherein the indicator string includes a unique character that indicates a specific attacker-controllable source of the at least one data flow.

14. The system of claim 11, wherein the system is further configured to:
generate a notification, based on the detecting of the indicator string, to indicate detection of DOM-XSS vulnerability.

15. The system of claim 14, wherein the notification includes at least one of: the at least one data flow, the attacker-controllable source, the security sensitive sink, and a sanitization effectivity.

16. The system of claim 11, wherein the system is further configured to:
retrieve the client-side code from a server; and
download the client-side code.

17. The system of claim 11, wherein the system is further configured to:
periodically repeat the detection of the DOM-XSS vulnerability.

18. The system of claim 11, wherein the system is further configured to:
identify at least one input string from a plurality of sinks;
search the at least one input string in a plurality of potential sources; and
determine a pair of the attacker-controllable source and the security sensitive sink based on identifying the at least one input string in the attacker-controllable source, wherein the attacker-controllable source is selected from the plurality of potential sources.

19. The system of claim 11, wherein the attacker-controllable source is selected from a predetermined list of potential attacker-controllable sources.
